(19) United States
(12) Patent Application Publication
(10) Pub. No.: US 2020/0145265 A1
(43) Pub. Date: May 7, 2020

(54) Device, Method, And System For Obscuring A Transmitted Radio Frequency Signal Using Polarization Modulation To Avoid Interception

(71) Applicant: The United States of America as represented by the Secretary of the Navy, San Diego, CA (US)

(72) Inventor: Gregory K. Fleizach, San Diego, CA (US)

(21) Appl. No.: 16/177,629

(22) Filed: Nov. 1, 2018

(51) Int. Cl. H04L 27/20; H01Q 21/24; H04B 7/10

(52) U.S. Cl. CPC H04L 27/2067; H04B 7/10; H01Q 21/245

(57) ABSTRACT

An in-phase quadrature (IQ) modulator modulates a radio frequency signal to produce an IQ-modulated radio frequency signal. A polarization modulator modulates the IQ modulated radio frequency signal to produce a polarization-modulated radio frequency signal. The polarization modulator outputs the polarization-modulated radio frequency signal to an antenna for transmission.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif. 92152; telephone: (619) 553-5118; email: ssc_pac_t2@navy.mil, referencing Navy Case 103762.

### BACKGROUND

Data transmitted as radio frequency signals over the air is susceptible to interception. Data encryption is commonly employed to protect the data in the case of an interception. While encrypting the data protects the contents, the signal externals of the radio frequency signal are still exposed. Much information can be gleaned from the signal externals, such as the frequency, the symbol rate, the data framing, and the modulation type. These parameters can be used by an interceptor to identify the class of transmitter or perhaps even uniquely identify a transmitter. Even just observing the schedule on which transmitters transmit can provide valuable information to an interceptor.

Information like data framing may be obscured by encryption, but the symbol rate and modulation type are still exposed to an interceptor. Additionally, encryption can be costly to implement and may be unnecessary for some situations.

Using highly directional transmitter antennas can help mitigate the interception problem. However, even highly directional transmissions are at a risk of being intercepted if an interceptor is positioned such that it is able to receive the transmission between the transmitting antenna and the receiving antenna.

For example, although microwave towers use very narrow beams for their point-to-point links, an interceptor receiver merely has to be placed between the two links to intercept the transmission. Moreover, highly directional systems make it important to maintain precise pointing. This is expensive and can be difficult for mobile devices that transmit radio frequency signals.

Typically, users simply accept that the signal externals of a transmitted radio frequency signal can be exploited, thinking that interception of the signal externals is unavoidable.

In view of the above, it would be desirable to have a technique for obscuring a transmitted radio frequency to avoid interception of the radio frequency signal.

### SUMMARY

The present disclosure pertains generally to transmission of radio frequency signals. More particularly, the present disclosure pertains to obscuring a transmitted radio frequency signal using polarization modulation to avoid interception.

According to an illustrative embodiment, an in-phase quadrature (IQ) modulator is configured to modulate a radio frequency signal to produce an IQ-modulated radio frequency signal. A polarization modulator is configured to modulate the IQ-modulated radio frequency signal to produce a polarization-modulated radio frequency signal. The polarization modulator is further configured to output the polarization-modulated radio frequency signal to an antenna for transmission.

These, as well as other objects, features and benefits will now become clear from a review of the following detailed description, the illustrative embodiments, and the accompanying drawings.

### BRIEF DESCRIPTION OF THE DRAWINGS

The novel features of the present disclosure will be best understood from the accompanying drawings, taken in conjunction with the accompanying description, in which similarly-referenced characters refer to similarly-referenced parts, and in which:

FIG. 1 illustrates a system for obscuring a transmitted radio frequency signal using polarization modulation according to one embodiment of the present disclosure.

FIG. 2 depicts a polarization diagram of an example of an elliptically polarized signal.

FIG. 3 is a flow chart depicting a method for obscuring a transmitted radio frequency signal using polarization modulation according to an illustrative embodiment of the present disclosure.

### DETAILED DESCRIPTION OF THE EMBODIMENTS

According to illustrative embodiments, interception of a transmitted radio frequency signal is avoided by obscuring the transmitted radio frequency signal. The transmitted radio frequency signal is obscured by using a polarization modulation approach hidden on top of an in-phase quadrature (IQ) modulation approach. For added robustness, a differential polarization modulation approach may be used. The embodiments described below can be applied to new systems or retrofitted onto existing systems.

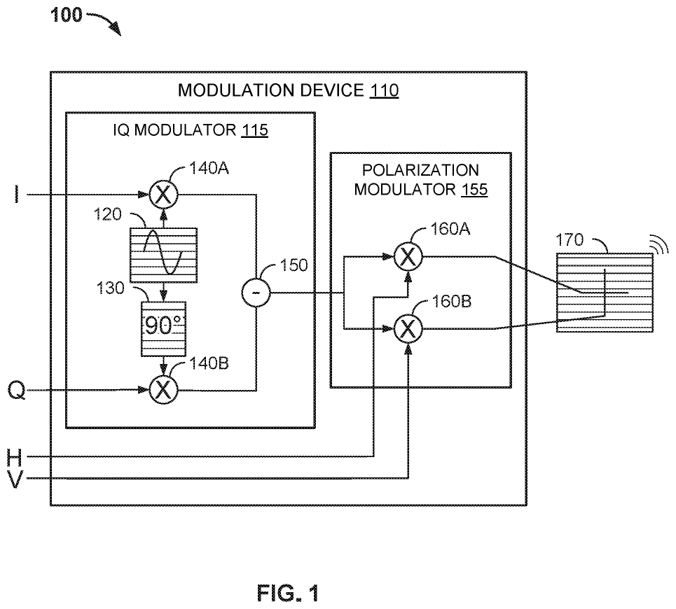

FIG. 1 illustrates a system for obscuring transmission of a radio frequency signal according to an illustrative embodiment. As shown in FIG. 1, the system 100 includes a modulation device 110 and an antenna 170.

The modulation device 110 includes an in-phase quadrature (IQ) modulator 115 that is configured to modulate a radio frequency signal with in-phase (I) and quadrature (Q) data to produce an IQ-modulated radio frequency signal. The IQ modulator 115 includes a local oscillator 120 that generates the radio frequency signal. The IQ modulator 115 also includes a phase shifter 130 that shifts the phase of the radio frequency signal by a number of degrees (e.g., ninety degrees (90°)). The IQ modulator 115 also includes a multiplier 140A that modulates the radio frequency signal generated by the local oscillator 120 with I data to produce an in-phase modulated signal and a multiplier 140B that modulates the phase-shifted radio frequency signal output by the phase shifter 130 with Q data to produce a phase-shifted modulated signal. The outputs of the multipliers 140A and 140B are fed to a subtraction circuit 150. The subtraction circuit 150 is configured to compute a difference between the in-phase modulated radio frequency signal and the phase-shifted modulated radio frequency signal and output the difference as an IQ-modulated radio frequency signal. Although not shown, a power amplifier may be used to amplify the IQ-modulated radio frequency signal.

The modulation device 110 also includes a polarization modulator 155 that is configured to modulate the IQ-modulated radio frequency signal output by the IQ modulator 115 to produce a polarization-modulated signal. Polarization modulation is achieved by generating a weighted horizontal component and a weighted vertical component of the IQ-modulated signal with horizontal (H) data and vertical (V) data, respectively. The polarization-modulated signal is output to an antenna 170 for transmission.

The polarization modulator 155 includes multipliers 160A and 160B that modulate the weighted horizontal component and the weighted vertical component, respectively. An output from the multiplier 160A is fed to a horizontal feed of the antenna 170, and an output from the multiplier 160B is fed to a vertical feed of the antenna 170.

The polarization modulator 155 weights the horizontal and vertical components of the IQ-modulated radio frequency signal by controlling the respective magnitudes of the horizontal component and the vertical component and the relative phase between the horizontal component and the vertical component. The respective magnitudes of the horizontal and vertical components and the relative phase between the horizontal component and the vertical component may be selected by a controller (not shown) based on the polarization of a presumed interceptor as described in more detail below. The controller may be manually or computer-controlled.

The respective magnitudes of the horizontal component and the vertical component and the relative phase between the horizontal component and the vertical component may also be adjusted by the controller as needed, e.g., to accommodate for changes in the polarization of the presumed interceptor. This may be useful, for example, for transmissions from a mobile device, such as a plane, which is likely to encounter interceptors having different polarizations as it moves through the air.

The IQ modulator 115 can be fed by real data or even “dummy” data. That is, the I data and Q data do not need to carry useful information. Primarily, the IQ modulation serves as a “cover” for the useful data being modulated in polarization by the polarization modulator 155. Just as the I data and the Q data modulate the amplitude, phase, and/or frequency of the locally generated radio frequency signal, the H data and the V data modulate the polarization of the IQ-modulated radio frequency signal output by the IQ modulator 115.

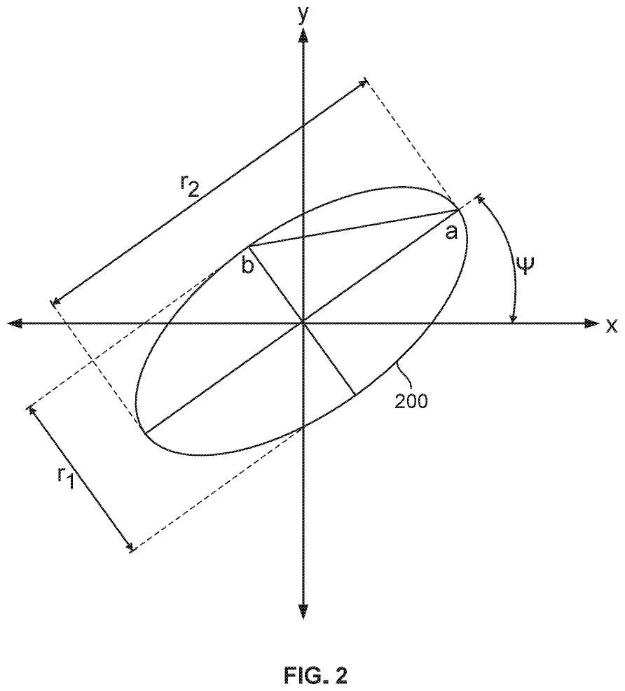

The shape of the polarization-modulated signal is governed by the respective magnitudes of the horizontal component and the vertical component and the relative phase between the horizontal component and the vertical component. This may be understood with reference to FIG. 2 which depicts a polarization diagram for an elliptically polarized signal 200. This elliptically polarized signal 200 includes a horizontal component and a vertical component.

In FIG. 2, the tilt of the elliptically polarized signal 200 with respect to a positive horizontal axis x is indicated by ψ (with y indicating a vertical axis). The “circularness” of the elliptically polarized signal, referred to as the signed inverse axial ratio (SIAR), is defined by the relationship between the length r₂ of a semi-major axis a and the length r₁ of a semi-minor axis b. These two parameters, ψ and SIAR, are defined by the respective magnitudes of the horizontal component and the vertical component and the relative phase between the horizontal component and the vertical component of the polarization-modulated radio frequency signal. These two parameters ψ and SIAR, in turn, define the polarization state of a polarized signal. Thus, the polarization state of a polarized signal is defined by the respective magnitudes of the horizontal component and the vertical component and the relative phase between the horizontal component and the vertical component of the polarization-modulated radio frequency signal.

As those skilled in the art will appreciate, if either the magnitude of the horizontal component or the vertical component is zero, the signal is linearly polarized. If the magnitude of the vertical component is 0, the signal is horizontally polarized and ψ is 0°. If the magnitude of the horizontal component is 0, the signal is vertically polarized, and ψ is 90°.

As those skilled in the art will further appreciate, if the relative phase between the horizontal component and the vertical component is 90°, and the respective magnitudes of the horizontal component and the vertical component are equal, the signal is circularly polarized. A circularly polarized signal has no tilt parameter.

The SIAR for a linearly polarized signal is zero (0). The SIAR for a right-hand circularly polarized signal is one (1), and the SIAR for a left-hand circularly polarized signal is negative one (−1). Elliptical polarizations have a tilt ψ between 0° and 180° and SIAR between −1 and 1.

Communications systems are typically circularly polarized or linearly polarized for convenience. Thus, interceptors are typically circularly or linearly polarized to detect transmitted radio frequency signals. An interceptor with a circularly polarized antenna can receive linearly polarized signals (though at a loss) and linearly polarized antennas can receive circularly polarized signals (though at a loss).

However, an interceptor with a circularly polarized antenna is insensitive to the tilt of an incoming radio frequency signal. Likewise, an interceptor with a linearly polarized antenna is insensitive to the SIAR of the incoming radio frequency signal if the power along the primary axis (horizontal or vertical) does not change. Therefore, with some knowledge of the interceptor, the system shown in FIG. 1 can be operated in such a manner that an interceptor, insensitive to changes in one polarization parameter or the other, will not be able to detect changes in the polarization. This allows the transmitter to effectively transmit “hidden” information in the polarization dimension while the interceptor continues to receive the IQ-modulated radio frequency signal. According to an illustrative embodiment, by varying the respective magnitudes of the horizontal component and the vertical component and/or the relative phase between the horizontal component and the vertical component, the ψ and SIAR of a polarization-modulated radio frequency may be varied to obscure the transmitted radio frequency signal from an interceptor.

For example, if a presumed interceptor has a linearly polarized receiver, then system 100 may be operated in a SIAR mode, and the polarization modulation will be transparent to the interceptor. The polarization modulation may adjust the SIAR from 0 to positive one (+1) or negative one (−1), so the polarization-modulated radio frequency signal will diverge from a linear polarization and become elliptical. The signal strength along the vertical axis can be kept constant while the SIAR is varied, such that a vertically polarized interceptor will not be able to detect the transmitted polarization-modulated radio frequency signal. Similarly, the signal strength along the horizontal axis can be kept constant while the SIAR is varied, such that a horizontally polarized interceptor will not be able to detect the transmitted polarization-modulated radio frequency signal.

As another example, if a presumed interceptor has a circularly polarized receiver, then the system 100 may be operated in the tilt mode, and the polarization will be transparent to the interceptor. The polarization modulation may adjust the tilt from 0° to 180°. Since the circularly polarized receiver will not recognize tilt, the circularly polarized interceptor will not detect any difference in signal strength.

According to an illustrative embodiment, a manual or computer-controlled switch may be used, as part of or in addition to the controller described above, to select between a SIAR and a tilt polarization modulation mode of the polarization modulator 155, depending on whether a known or anticipated interceptor is linearly polarized or circularly polarized. That is, if the known or anticipated interceptor is linearly polarized, the polarization modulator 155 shown in FIG. 1 is operated in SIAR mode, as the linearly polarized interceptor will not notice variations in SIAR.

For an interceptor presumed to have a vertically polarized antenna, the magnitude of the horizontal component may be adjusted, and the magnitude of the vertical component may be kept constant. That is, a vertically polarized antenna is insensitive to changes in the horizontal component of the signal. For an interceptor presumed to have a horizontally polarized antenna, the magnitude of the vertical component may be adjusted, while the magnitude of the horizontal component is kept constant. In either case, the relative phase between the horizontal and vertical components is controlled to be either zero (0) or one hundred eighty (180).

Similarly, if the known or anticipated interceptor is presumed to have a circularly polarized antenna, the polarization modulator 155 shown in FIG. 1 is operated in tilt mode, as the circularly polarized antenna cannot measure variations in tilt. In the tilt mode, the respective magnitudes of and the relative phase between the horizontal component and the vertical component are controlled such that they change the polarization tilt of the signal.

The embodiment described above uses an absolute polarization modulation approach and is most effective for those scenarios in which the transmitter geometry and the receiver geometry is fixed or known, as variations in geometry may affect tilt measurements. For example, if a horizontally polarized transmit antenna is rotated 90° with respect to the receiver, the transmitter will appear to be a vertically polarized transmitter to the receiver. Similarly, if the transmitter remains stationary and the receiver rotates, the perceived polarization will change for a linearly polarized signal. In addition, polarization modulation is sensitive to various atmospheric effects.

To account for atmospheric effects and for those cases in which the transmitter and receiver geometry is not fixed or known, according to another embodiment, a differential polarization modulation approach may be used. According to this embodiment, the respective magnitudes of the horizontal component and the vertical component and the relative phase between the horizontal component and vertical component may be controlled based on the polarization state difference between a current polarization state and a previous polarization state. As may be understood from the discussion above, the current polarization state is defined by selected respective magnitudes of the horizontal component and the vertical component and the selected relative phase between the horizontal component and the vertical component. Similarly, the previous polarization state is defined by previously selected respective magnitudes of the horizontal component and the vertical component and a previously selected relative phase between the horizontal component and the vertical component.

As noted above, the respective magnitudes between the horizontal component and the vertical component and the relative phase between the horizontal component and the vertical component define the SIAR and tilt of a polarization-modulated signal. Thus, the differential values between the current polarization state and the previous polarization state also correspond to differences in SIAR and tilt. As interceptors are typically either linearly polarized or circularly polarized, the differential values between the current polarization state and the previous polarization state would either correspond to SIAR differences (to avoid interception by a linearly polarized interceptor) or a tilt difference (to avoid interception by a circularly polarized interceptor).

The polarization state difference may be determined by a computer-controlled subtraction circuit that stores a previous polarization state and subtracts the previous polarization state from the current polarization state before providing the inputs to the multipliers 160A and 160B. Alternatively, the polarization state difference may be computed by subtraction circuits inserted between the outputs of the multipliers 160A and 160B and the inputs of the multipliers 160A and 160B.

The differential polarization modulation technique is advantageous in that it does not require the transmitter and receiver to be geometrically synchronized. This is analogous to differential binary phase shift keying (DBPSK) modulation, which obviates the need to perform phase synchronization since the absolute phase is not necessary. As with DBPSK, there is some loss (i.e. higher bit error ratio (BER) for a given energy per bit to noise power spectral density radio (Eb/No)) associated with differential polarization modulation compared to absolute polarization modulation. However, differential polarization modulation overcomes some of the geometry and environmental issues that may be associated with absolute polarization and may be more practical to implement.

According to illustrative embodiments, the magnitude of polarization modulation (i.e., the adjustment of the tilt or SIAR) applied can be quite low and even on the order of the environmental effects. By modulating a pseudo-random noise (PN) polarization sequence of appropriate length onto the signal and transmitting the polarization-modulated signal below the noise floor, it may be possible to integrate the polarization-modulated signal with an operation analogous to a matched filter to find the transmitted signal at a receiver. By using small adjustments in the tilt or SIAR to match the level of variations caused by environmental conditions, the polarization modulation will appear to be simply environmental or system noise to an interceptor. In this way, the transmitted radio frequency signal could be further obscured by spreading the polarization-modulated signal into the polarization noise.

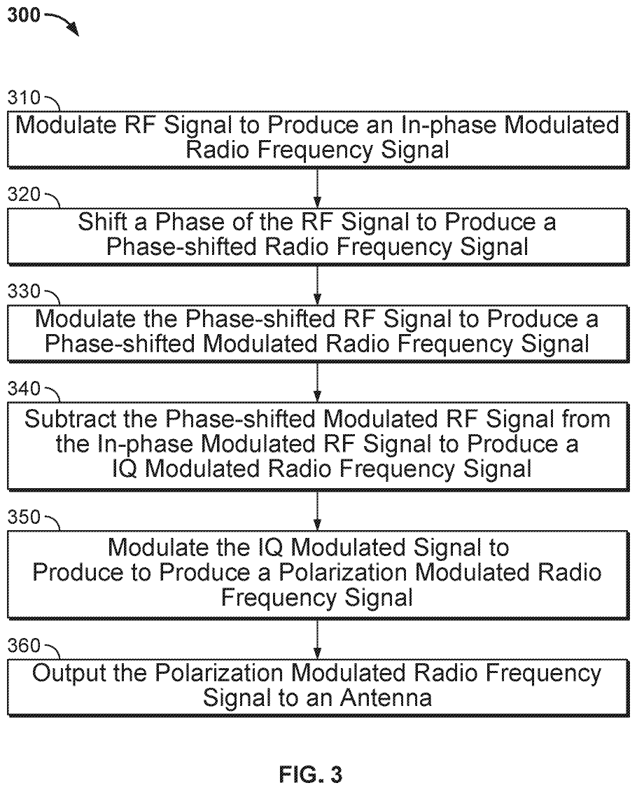

FIG. 3 is a flow chart showing steps of a method for obscuring a transmitted radio frequency signal to avoid interception according to an illustrative embodiment. The method 300 begins with modulating a radio frequency signal (e.g., by the IQ-modulator 115 shown in FIG. 1) to produce an IQ-modulated radio frequency signal. This includes performing steps 310-340 as shown in FIG. 3.

At step 310, a radio frequency signal is modulated to produce an in-phase modulated radio frequency signal. At step 320, a phase of the radio frequency signal is shifted to produce a phase-shifted radio frequency signal. At step 330, the phase-shifted radio frequency signal is modulated to produce a phase-shifted modulated radio frequency signal. At step 340, the phase-shifted modulated radio frequency signal is subtracted from the in-phase modulated radio frequency signal to produce an IQ-modulated radio frequency signal.

Next, at step 350, the IQ-modulated radio frequency signal is modulated by, e.g., the polarization modulator 155 shown in FIG. 1, to produce a polarization-modulated radio frequency signal. This may include weighting a horizontal component and a vertical component of the IQ-modulated radio frequency signal by controlling the respective magnitudes of the horizontal component and the vertical component and the relative phase between the horizontal component and the vertical component as described above. The respective magnitudes of the horizontal component and the vertical component and the relative phase between the horizontal component and the vertical component may be selected to avoid interception by an interceptor having an antenna with a presumed polarization. At step 360, the polarization-modulated radio frequency signal is output to an antenna (e.g., the antenna 170 shown in FIG. 1) for transmission.

It should be appreciated that fewer, additional, or alternative steps may also be involved in the method and/or some steps may occur in a different order. For example, although not shown in FIG. 3, the method 300 may include a step for determining a polarization state difference between a current polarization state and the previous polarization state and controlling the respective magnitudes of the horizontal component and the relative phase between the horizontal component and the vertical component based on the polarization state difference. Also, the method may include a step for adjusting selected respective magnitudes of the horizontal component and a selected relative phase between the horizontal component and the vertical component to avoid interception of the transmitted polarization-modulated radio frequency signal, e.g., in case the presumed polarization of an interceptor antenna changes.

It will be understood that many additional changes in the details, materials, steps and arrangement of parts, which have been herein described and illustrated to explain the nature of the subject matter of the present disclosure, may be made by those skilled in the art within the principle and scope of the present disclosure as expressed in the appended claims.

1. A device, comprising:
an in-phase quadrature (IQ) modulator configured to modulate a radio frequency signal to produce an IQ-modulated radio frequency signal;
a polarization modulator configured to:
modulate the IQ-modulated radio frequency signal to produce a polarization-modulated radio frequency signal; and
output the polarization-modulated radio frequency signal to an antenna for transmission; and
a controller configured to enable the polarization modulator to operate in one of a signed inverse axial ratio (SIAR) polarization modulation mode or a tilt polarization modulation mode.

2. The device of claim 1, wherein the IQ modulator is configured to modulate the radio frequency signal to produce an in-phase modulated radio frequency signal.

3. The device of claim 2, wherein the IQ modulator is further configured to shift a phase of the radio frequency signal to produce a phase-shifted radio frequency signal and modulate the phase-shifted radio frequency signal to produce a phase-shifted modulated radio frequency signal.

4. The device of claim 3, wherein the IQ modulator is further configured to determine a difference between the in-phase modulated radio frequency signal and the phase-shifted modulated radio frequency signal and output the difference as the IQ-modulated radio frequency signal.

5. The device of claim 1, wherein the polarization modulator is configured to modulate the IQ-modulated radio frequency signal by weighting a horizontal component and a vertical component of the IQ-modulated radio frequency signal.

6. The device of claim 5, wherein weighting includes controlling respective magnitudes of the horizontal component and the vertical component and a relative phase between the horizontal component and the vertical component to avoid interception of the polarization-modulated radio frequency signal transmitted by the antenna.

7. The device of claim 6, wherein the respective magnitudes of the horizontal component and the vertical component and the relative phase between the horizontal component and the vertical component define a tilt and a signed inverse axial ratio (SIAR) of the polarization-modulated radio frequency signal.

8. A method, comprising:
modulating a radio frequency signal to produce an in-phase modulated radio frequency signal;
shifting a phase of the radio frequency signal to produce a phase-shifted radio frequency signal;
modulating the phase-shifted radio frequency signal to produce a phase-shifted modulated radio frequency signal;
subtracting the phase-shifted modulated radio frequency signal from the in-phase modulated radio frequency signal to produce an IQ-modulated radio frequency signal; and
modulating the IQ-modulated radio frequency signal by weighting a horizontal component and a vertical component of the IQ-modulated radio frequency signal to produce a polarization-modulated radio frequency signal;
outputting the polarization-modulated radio frequency signal to an antenna for transmission; and
controlling the modulating of the IQ-modulated radio frequency signal so as to modulate the IQ-modulated radio frequency signal in one of a signed inverse axial ratio (SIAR) polarization modulation mode or a tilt polarization modulation mode.

9. The method of claim 8, further comprising transmitting the polarization-modulated radio frequency signal by the antenna.

10. The method of claim 8, wherein weighting the horizontal component and the vertical component comprises controlling respective magnitudes of the horizontal component and the vertical component and controlling a relative phase between the horizontal component and the vertical component.

11. The method of claim 10, wherein the respective magnitudes of the horizontal component and the vertical component and the relative phase between the horizontal component and the vertical component are controlled to have respective selected magnitudes and a selected relative phase to avoid interception of the polarization-modulated radio frequency signal transmitted by the antenna.

12. The method of claim 11, wherein controlling the respective magnitudes of the horizontal component and the vertical component and the relative phase between the horizontal component and the vertical component further comprises adjusting the selected respective magnitudes of the horizontal component and the vertical component and the selected relative phase between the horizontal component and the vertical component to avoid the interception of the polarization-modulated radio frequency signal transmitted by the antenna.

13. The method of claim 11, wherein the selected respective magnitudes and the selected relative phase difference define a current polarization state of the polarization-modulated radio frequency signal, and wherein previously selected respective magnitudes and a previously selected relative phase difference define a previous polarization state of the polarization-modulated radio frequency signal.

14. The method of claim 13, further comprising determining a polarization state difference between the current polarization state and a previous polarization state.

15. The method of claim 14, wherein the respective magnitudes of the horizontal component and the vertical component and the relative phase between the horizontal component and vertical component are further controlled based on the polarization state difference.

16. A system, comprising:
an in-phase quadrature (IQ) modulator configured to:
modulate a radio frequency signal to produce an in-phase modulated radio frequency signal;
shift a phase of the radio frequency signal to produce a phase-shifted radio frequency signal;
modulate the phase-shifted radio frequency signal to produce a phase-shifted modulated radio frequency signal;
determine a difference between the in-phase modulated radio frequency signal and the phase-shifted modulated radio frequency signal; and
output the difference as an IQ-modulated radio frequency signal;
a polarization modulator configured to:
modulate a polarization of the IQ-modulated radio frequency signal to produce a polarization-modulated radio frequency signal by controlling respective magnitudes of a horizontal component and a vertical component of the IQ-modulated radio frequency and controlling a relative phase between the horizontal component and the vertical component;
a controller configured to enable the polarization modulator to operate in one of a signed inverse axial ratio (SIAR) polarization modulation mode or a tilt polarization modulation mode; and
an antenna configured to transmit the polarization-modulated radio frequency signal.

17. The system of claim 16, wherein the respective magnitudes of the horizontal component and the vertical component and the relative phase between the horizontal component and the vertical component are selected to avoid interception of the polarization-modulated radio frequency signal transmitted by the antenna.

18. The system of claim 17, wherein the polarization modulator is configured to control the respective magnitudes of the horizontal component and the vertical component to have selected respective magnitudes and to control the relative phase been the horizontal component and the vertical component to have a selected relative phase.

19. The system of claim 18, wherein the selected respective magnitude and the selected relative phase difference define a current polarization state of the polarization-modulated radio frequency signal, and previously selected respective magnitudes and a previously selected relative phase difference define a previous polarization state of the polarization-modulated radio frequency signal.

20. The system of claim 19, wherein the polarization modulator is configured to control the respective magnitudes of the horizontal component and the vertical component and the relative phase between the horizontal component and the vertical component based on a polarization state difference between the current polarization state and the previous polarization state.
